(19) United States
(12) Patent Application Publication
(10) Pub. No.: US 2007/0060296 A1
(43) Pub. Date: Mar. 15, 2007

(54) Gaming machine

(75) Inventor: Kazumasa Yoshizawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/518,183

(22) Filed: Sep. 11, 2006

(30) Foreign Application Priority Data
Sep. 9, 2005 (JP) 2005-262124

(51) Int. Cl. A63F 13/00

(52) U.S. Cl. 463/20

(57) ABSTRACT

Display effects of symbols may enhance expectation of a player with “mecha-reels” and video reels in a superposed manner. Symbol images and symbols are displayed statically in variable display windows 22, 23, 24 in a state of disenabling a transmissive display of reels and/or in a state of enabling the transmissive display of the reels after one of patterns A, B, C, and D, in which each display window is made in either transmissive state or non-transmissive state based on sampled random numbers and a table setting for each winning combination of the selected symbols such that the variable display windows 22, 23, 24 of the lower display device 4 would be switched between in the transmissive state and in the non-transmissive state so as to make the reels disposed behind the variable display windows 22, 23, 24 between visible and invisible.

### CROSS REFERENCE TO RELATED APPLICATIONS

This application is based upon and claims the benefits of priorities from Japanese Patent Application No. 2005-262124 filed on Sep. 9, 2005, the entire contents of which are incorporated herein by reference.

### FIELD OF THE INVENTION

The present invention relates to a gaming machine in which a game is played with symbols to be displayed variably and stopped to be displayed statically.

### RELATED ART

In a conventional gaming machine, for example, a slot machine, a plurality of reels are rotated mechanically such that, when a combination of symbols being displayed statically after the reels are stopped includes any one of winning combinations, a payout corresponding to such a winning combination is paid out (refer to Japanese unexamined patent application publication No. 2003-284809).

Also, in a slot machine recently being introduced, a video reel which displays variably various kinds of combinations of symbols by images and stops such variable display of combinations of symbols so as to display a combination of symbols statically may be employed instead of the above-mentioned reels rotating mechanically (to be referred to as “mecha-reel”).

However, in either slot machine, the “mecha-reel” or video reel is employed alternatively to display a combination of symbols such that display effects of the combination of symbols to be displayed variably and stopped to be displayed statically are performed in a uniform manner so as not to appeal to players.

### SUMMARY OF THE INVENTION

In the present invention, in considering the above, a gaming machine may be provided such that the mecha-reel and the video reel are employed in a superposed way therein so as to agitate expectations of the players by display effects of the combination of symbols.

According to the present invention, a gaming machine comprises: a plurality of display windows being composed of a video display which can display variably and statically images of a plurality of symbols; a plurality of mechanical reels being disposed behind the plurality of display windows, respectively, and being composed of peripheral surfaces on which a plurality of symbols are disposed, the plurality of symbols being displayed variably and statically through the plurality of display windows as the windows are in a transmissive state; and a processor in communication with the display windows and the reels. The processor is operable to: (a) select a plurality of symbols to be displayed statically as a game result by lottery; (b) determine whether each of the plurality of display windows is made in the transmissive state or a non-transmissive state based on a combination of the selected symbols; (c) display symbols of reels through corresponding display windows in the transmissive state and images of symbols on display windows in the non-transmissive state as the game result; and (d) award a player based on the game result when the game result corresponds to a predetermined winning combination of symbols.

Further features of the present invention, its nature, and various advantages will be more apparent from the accompanying drawings and the following description of the preferred embodiment.

### BRIEF DESCRIPTION OF THE DRAWINGS

FIG. 1 is a view showing an outline of an embodiment of the present invention.

FIG. 2 is a perspective view showing a slot machine.

FIG. 3 is a longitudinal section view showing a lower liquid crystal display and a reel.

FIG. 4 is an exploded perspective view of the lower liquid crystal display.

FIG. 5 is a block diagram showing schematically a control system of the slot machine.

FIG. 6 is a block diagram showing schematically a liquid crystal driving circuit.

FIGS. 7A and 7B are drawings showing columns of symbols to be displayed variably as being scrolled in each of the variable display windows of the lower liquid crystal display during the game.

FIG. 8 is an illustrative drawing showing a lottery table of symbols to be displayed statically when three variable display windows are used for the game.

FIG. 9 is an illustrative drawing showing winning combinations and payout rates thereof when three variable display windows are used for the game.

FIG. 10 is an illustrative drawing showing a table to be used to determine whether the variable display windows are to be in a state enabling a transmissive display or in a state disenabling a transmissive display when “7-7-7” winning combination is won as three variable display windows are used for the game.

FIG. 11 is an illustrative drawing showing a table to be used to determine whether the variable display windows are to be in a state enabling a transmissive display or in a state disenabling a transmissive display when “3BAR-3BAR-3BAR” winning combination is won as three variable display windows are used for the game.

FIG. 12 is an illustrative drawing showing a table to be used to determine whether the variable display windows are to be in a state enabling a transmissive display or in a state disenabling a transmissive display when “2BAR-2BAR-2BAR” winning combination is won as three variable display windows are used for the game.

FIG. 13 is an illustrative drawing showing a table to be used to determine whether the variable display windows are to be in a state enabling a transmissive display or in a state disenabling a transmissive display when “BAR-BAR-BAR” winning combination is won as three variable display windows are used for the game.

FIG. 14 is an illustrative drawing showing a table to be used to determine whether the variable display windows are to be in a state enabling a transmissive display or in a state disenabling a transmissive display when “Cherry-Cherry-Cherry” winning combination is won as three variable display windows are used for the game.

FIG. 15 is an illustrative drawing showing a table to be used to determine whether the variable display windows are to be in a state enabling a transmissive display or in a state disenabling a transmissive display when the losing combination is obtained as three variable display windows are used for the game.

FIG. 16 is a flow chart of a main process program.

FIG. 17 is a flow chart of a start acceptance process program.

FIG. 18 is a flow chart of a lottery process program.

FIG. 19 is a flow chart of a game process program.

FIG. 20 is an illustrative drawing showing a lottery table of winning combinations and payout rates thereof.

### DESCRIPTION OF THE PREFERRED EMBODIMENT

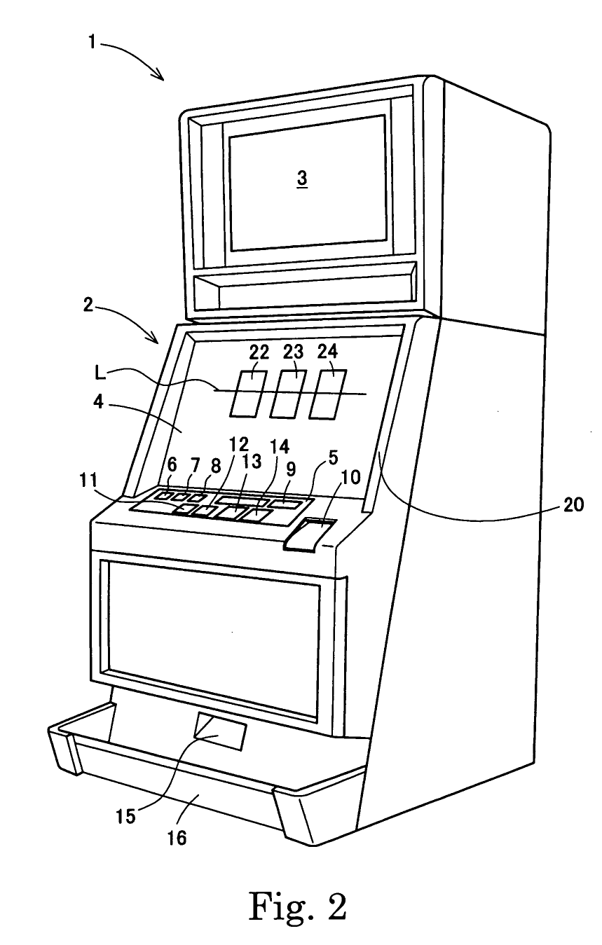

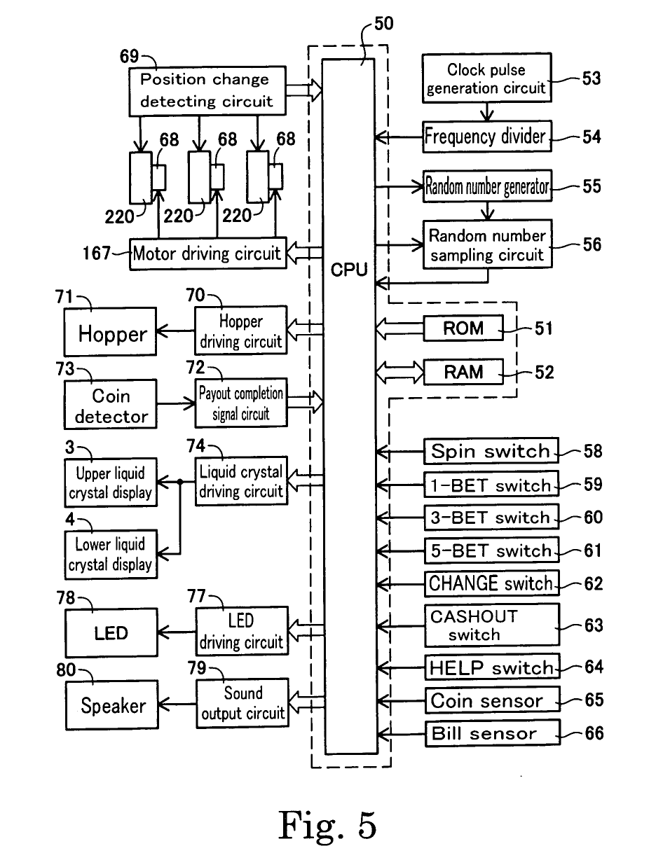

In the following, a detailed explanation of a gaming machine is made with reference to the attached drawings according to the present invention based on a slot machine by way of example. First, an outline structure of the slot machine according to the present embodiment is explained with reference to FIGS. 2 and 5. FIG. 2 is a perspective view of the slot machine. FIG. 5 is a block diagram schematically illustrating a control system of the slot machine.

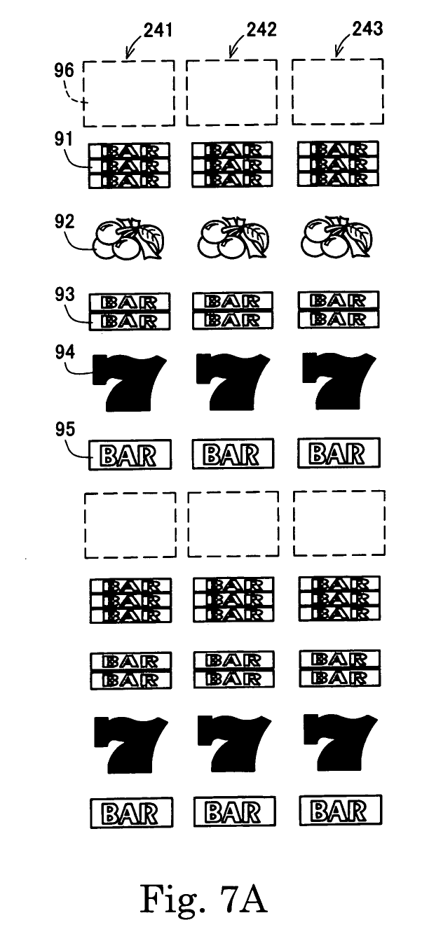

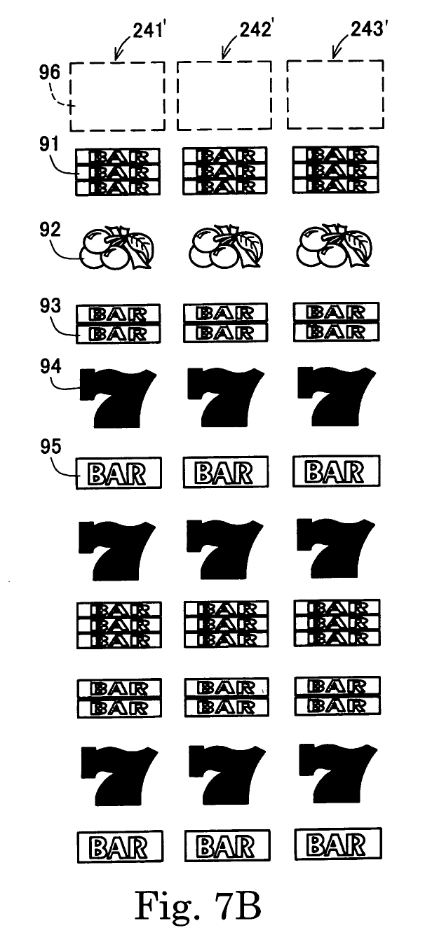

In FIG. 2, a slot machine 1 is provided with a cabinet 2 forming an outer shape thereof, an upper liquid crystal display 3 being disposed on an upper portion of the front face of the cabinet 2, and a lower liquid crystal display 4 being disposed on a central portion of the front face of the cabinet 2 and inside a machine front panel 20. Here, the upper liquid crystal display 3 comprises a liquid crystal display for general use, and the lower liquid crystal display 4 comprises a so-called transparent liquid crystal display. The upper liquid crystal display 3 displays a gaming method, kinds of winning combinations and payout rates thereof, and information related to the game such as various kinds of effects to be performed during the game. In addition, the lower liquid crystal display 4 displays three variable display windows 22, 23, and 24, as well as a pay line L, as shown in FIG. 2. Moreover, the variable display windows 22, 23, and 24 display variably columns of symbols 241 to 243 of FIG. 7 to be described later as they are scrolled from top to bottom. A detailed structure of the lower liquid crystal display 4 will be described later.

An operation table 5 protruding frontward is provided on the bottom side of the lower liquid crystal display 4, to which a change (“CHANGE”) button 6, a payout (“CASH-OUT”) button 7 and a help (“HELP”) button 8 are provided from the far left to the right. A coin insertion part 9 and a bill insertion part 10 are provided to the right of the HELP button 8. In addition, a 1-BET button 11, a spin (“SPIN/REPEAT-BET”) button 12, a 3-BET button 13, and a 5-BET button 14 are provided to the near side of the operation table 5 from left to right.

Here, the change button 6 serves as a button which is pressed when changing a bill (paper money) having been inserted through the bill insertion part 10; and the coins into which the bill is changed are discharged from a coin payout opening 15 into a coin receiving part 16, both of which are provided to a lower portion of the cabinet 2. A change (“CHANCE”) switch 62 to be described later is attached to the change button 6. When the change button 6 is pressed, a switch signal from the change switch 62 is outputted to the CPU 50 based on the depression of the button (refer to FIG. 5).

The payout button 7 serves as a button which is pressed when the game is completed. When the payout button 7 is pressed, coins having been acquired during the game are paid out through the coin payout opening 15 onto the coin receiving part 16. A payout (“CASH-OUT”) switch 63 is attached to the payout button 7. When the payout button 7 is pressed, a switch signal from the payout switch 63 is outputted to the CPU 50 based on the depression of the button (refer to FIG. 5).

The help button 8 serves as a button which is pressed when the operation method or the like is not clear such that various kinds of help information are displayed on the upper liquid crystal display 3 when the help button 8 is pressed. A help (“HELP”) switch 64 to be described later is attached to the HELP button 8. When the HELP button 8 is pressed, a switch signal from the HELP switch 64 is outputted to the CPU 50 based on the depression of the button (refer to FIG. 5).

A coin sensor 65 to be described later is provided to the coin insertion part 9 such that a coin detection signal is outputted to the CPU 50 via the coin sensor 65 when coins are inserted into the coin insertion part 9 (refer to FIG. 5).

A bill sensor 66 to be described later is provided to the bill insertion part 10 such that a bill detection signal is outputted to the CPU 50 via the bill sensor 66 when the bill is inserted into the bill insertion part 10 (refer to FIG. 5).

The 1-BET button 11 is a button to be pressed so that one bet is placed at every depression thereof. A 1-BET switch 59 is attached to the 1-BET button 11 such that a switch signal is outputted to the CPU 50 from the 1-BET switch 59 based on the depression of the button when the 1-BET button 11 is pressed (refer to FIG. 5).

The spin (“SPIN/REPEAT-BET”) button 12 serves as a button to be pressed so as to initiate variable display of the symbols in the variable display windows 22 to 24 on the lower liquid crystal display 4 based on the depression of the button so that the game is to be started with the current bet number or the previously-employed bet number. A spin switch 58 to be described later is attached to the spin button 12 such that a switch signal from the spin switch 58 is outputted to the CPU 50 based on the depression of the button when the spin button 12 is pressed (refer to FIG. 5). The bet numbers that can be selected by pressing the spin button 12 include 1, 2, 3, and 5 bets.

The 3-BET button 13 is a button to be pressed so that 3 bets are placed based on depression thereof. A 3-BET switch 60 to be described later is attached to the 3-BET button 13 such that a switch signal from the 3-BET switch 60 is outputted to the CPU 50 based on the depression of the button when the 3-BET button 13 is pressed (refer to FIG. 5).

The 5-BET button 14 is a button to be pressed so that 5 bets are placed based on depression thereof. A 5-BET switch 61 to be described later is attached to the 5-BET button 14 such that a switch signal from the 5-BET switch 61 is outputted to the CPU 50 based on the depression of the button when the 5-BET button 14 is pressed (refer to FIG. 5).

The coin payout opening 15 is formed on the lower portion of cabinet 2, and the coin receiving part 16 for receiving discharged coins is provided thereto. A coin detector 73 to be described later comprising a sensor and the like is provided inside the coin payout opening 15 such that the coin detector 73 detects the number of coins discharged from the coin payout opening 15 (refer to FIG. 5).

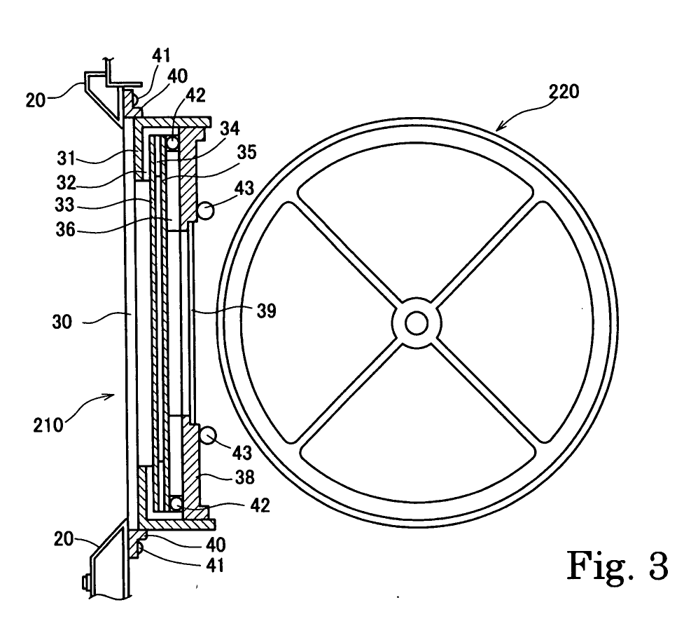

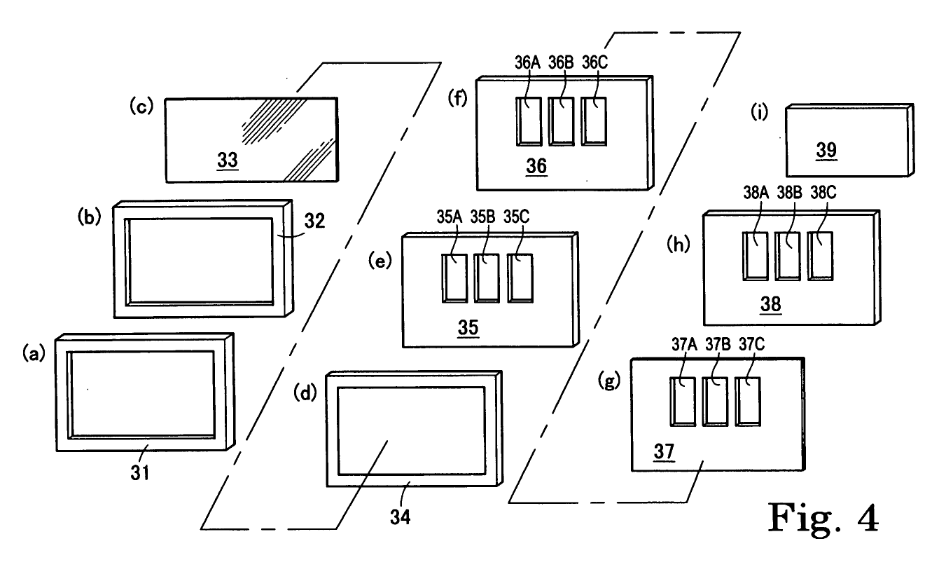

In the following, an explanation of the detailed structure of the lower liquid crystal display 4 and reels rotatably provided to the back side of the lower liquid crystal display 4 in the cabinet 2 is made with reference to FIGS. 3 and 4. FIG. 3 is a longitudinal sectional view showing the lower liquid crystal display and one of the reels, while FIG. 4 is an exploded perspective view of the lower liquid crystal display. In FIGS. 3 and 4, the lower liquid crystal display 4 is provided within a display window 210 of the machine front panel 20, which is provided to a center portion on the front face of the cabinet 2 of the slot machine 1. In addition, on the back side of the lower liquid crystal display 4 (in a middle part on the right side of FIG. 3), three reels 220 (only one of the reels 220 is shown in FIG. 3) are provided in a parallel arrangement, and each of the reels is supported in an independently rotatable manner. Specifically, as shown in FIG. 3, the lower liquid crystal display 4 is disposed in front of the three reels 220.

Here, an explanation of each reel 220 is made. From among the three reels 220, as seen from the front of the slot machine 1, the left reel 220 opposes to the variable display window 22 formed on the lower liquid crystal display 4 (refer to FIG. 2), the center reel 220 opposes to the variable display window 23 formed on the lower liquid crystal display 4 (refer to FIG. 2), and the right reel 220 opposes to the variable display window 24 formed on the lower liquid crystal display 4 (refer to FIG. 2). The configuration of each of the variable display windows 22 to 24 are described later.

In the following, an explanation of the structure of the lower liquid crystal display 4 is made with reference to FIGS. 3 and 4. In FIGS. 3 and 4, the lower liquid crystal display 4 comprises a transparent panel 30, a reel glass base 31, a bezel metal frame 32, a liquid crystal panel 33, a liquid crystal holder 34, a diffusion sheet 35, a light guide 36, a white reflector 37, a rear holder 38, and an antistatic sheet 39, which are named in the order from the front side of the slot machine 1. Openings 35A, 35B, and 35C are provided to the diffusion sheet 35. Similarly, openings 36A, 36B and 36C; openings 37A, 37B, and 37C; and opening 38A, 38B, and 38C are provided to the light guide 36, the white reflector 37, and the rear holder 38, respectively, so as to correspond to the openings 35A, 35B, and 35C, respectively. The openings 35A to 38A are superposed one after another so as to correspond to each other such that the variable display window 22 is formed (refer to FIG. 2). Similarly, the openings 35B to 38B form the variable display window 23 (refer to FIG. 2), and openings 35C to 38C form the variable display window 24 (refer to FIG. 2).

The openings 35A to 35C of the diffusion sheet 35 and the openings 36A to 36C of the light guide 36 constitute a transparent region for the purpose of securing visibility of the variable display windows 22 to 24.

In order to mount the lower liquid crystal display 4 on the display window 210 of the machine front panel 20, as shown in FIG. 3, brackets 40, which are provided on the top and bottom sides of the reel glass base 31 to hold the base, are fixed to the back side of the machine front panel 20 by means of screws 41.

A pair of cathode ray tubes 42 is provided to the top and bottom end edges of the light guide 36 as the light source for the liquid crystal panel 33. In addition, a pair of cold cathode ray tubes 43 is provided to the upper and lower portions of the back side of the openings 38A to 38C of the rear holder 38. The cold cathode ray tubes illuminate the symbols formed on the outer peripheral surfaces of the reels 220.

The liquid crystal panel 33 is a transparent electrical display panel composed of ITO or the like which is provided on the front panel of the reels 220 and through which the reels 220 are visible. The back side of the area around the display windows is held in the liquid crystal holder 34. The light guide 36 comprises an optically transparent resin panel and is provided with a lens-cut which allows the light emitted from the cold cathode ray tubes 42 located on the side to pass to the back side of the liquid crystal panel 33. The diffusion sheet 35 comprises an optically transparent resin panel that diffuses the light guided by the light guide 36, and makes uniform the light irradiated onto liquid crystal panel 33. The diffusion sheet 35, the light guide 36, and the liquid crystal holder 34 for holding the liquid crystal panel 33 are integrated, and the peripheral surfaces thereof are inserted into the bezel metal frame 32. Through this insertion, a front side of a display component of the liquid crystal panel 33 is held in the bezel metal frame 32.

The peripheral surfaces of the liquid crystal holder 34, the diffusion sheet 35, and the light guide 36, which have been integrated by being fitted into the bezel metal frame 32, are further inserted into the reel glass base 31, and are held by the reel glass base 31, with the front side of the display component of liquid crystal panel 33 open. The transparent panel 30 is bonded by compression to the front side of the reel glass base 31 and superposed on the front side of the display component of the liquid crystal panel 33 by mounting of the reel glass base 31 onto the machine front panel 20 via screws 41.

The rear holder 38 is composed of a white resin panel and holds the following components against the reel glass base 31 from the back: the bezel metal frame 32 supported by the reel glass base 31, the liquid crystal holder 34 that holds the liquid crystal panel 33, the diffusion sheet 35, and the light guide 36. The rear holder 38 also functions as a reflector whereby the light emitted by the cold cathode ray tubes 42 toward the light guide 36 is reflected onto the liquid crystal panel 33. The antistatic sheet 39 is transparent, is attached to the back side of rear holder 38 by double-sided tape, and covers the back side of the openings 38A to 38C formed in the rear holder 38.

Various kinds of symbol combinations used in the game are formed on the peripheral surfaces of the reels 220, as shown in FIG. 7A. FIGS. 7A shows columns of symbols which are variably displayed during the game and are scrolled down in the variable display windows 22 to 24 of the lower liquid crystal display 4. In FIG. 7A, the column of symbols 241 represents a symbol set which is variably displayed in the variable display window 22, the column of symbols 242 represents a symbol set which is variably displayed in the variable display window 23, and the column of symbols 243 represents a symbol set which is variably displayed in the variable display window 24.

Here, the columns of symbols 241 to 243 are identical to each other, and each column of symbols constitutes 11 symbol combinations appropriately formed from a triple BAR 91, cherry 92, double BAR 93, seven 94, single BAR 95, and blank (region in which no symbol is present) 96.

When forming various types of symbol combinations on the peripheral surfaces of the reels 220, a common procedure is adopted in which 11 symbol combinations are printed on long reel sheets that have corresponding features to the width and circumference lengths of the reels 220, and the reel sheets are then attached to the peripheral surface of the reels 220. It is apparent, however, that it is also possible to form the symbols by using a different procedure. Further, the same columns of symbols 241 to 243 are employed for vide reels such that symbols are displayed in any of the variable display windows 22 to 24.

FIG. 7B also shows various kinds of symbol combinations of another embodiment which can be used in the game to be displayed on the variable display windows 22 to 24 when the variable display windows 22 to 24 become non-transmissive.

In the following, an explanation of a structure related to the control system of the slot machine 1 is made with reference to FIG. 5. FIG. 5 is a block diagram schematically showing a control system of the slot machine.

In FIG. 5, the control system of the slot machine 1 is basically configured with the CPU 50 as a core component; and ROM 51 and RAM 52 are connected to the CPU 50. The ROM 51 stores a main process program to be described later, a start acceptance process program, a payout program, a game process program, a lottery table for selecting symbols to be stopped and displayed statically, and other various programs necessary for controlling the slot machine 1 and the data tables. The RAM 52 is memory which temporarily stores various kinds of data having been computed by the CPU 50.

A clock pulse generating circuit 53 for generating a basic clock pulse and a frequency divider 54 are connected to the CPU 50. A random number generator 55 for generating random numbers and a random sampling circuit 56 are also connected to the CPU 50. The random numbers which are sampled through random number sampling circuit 56 are utilized for various kinds of winning combinations and other lottery drawings. Furthermore, the CPU 50 is also connected to the spin switch 58 attached to the spin (“SPIN/REPEAT-BET”) button 12; the 1-BET switch 59 attached to the 1-BET button 11; the 3-BET switch 60 attached to the 3-BET button 13; the 5-BET switch 61 attached to the 5-BET button 14; the change (“CHANGE”) switch 62 attached to the change button 6; the payout (“CASH-OUT”) switch 63 attached to the payout button 7; and the help (“HELP”) switch 64 attached to the help button 8. The CPU 50 controls operations that correspond to each button on the basis of the switch signals which are outputted from the above switches.

Three step motors 68 for rotating the reels 220 via a motor driving circuit 167 are connected to the CPU 50. A position change detection circuit 69 is also connected to the CPU 50. When the CPU 50 outputs a motor drive signal (command pulse) to the motor driving circuit 167, each of the step motors 68 is rotated and driven by excitation signals outputted from the motor driving circuit 167. The reels 220 are thereby rotated.

At this time, the CPU 50 counts the number of drive pulses supplied to each of the step motors 68. The CPU 50 determines the rotational positions of the symbols on the reels 220 based on the number of drive pulses counted, controls the stop positions, and the like.

A position change detection circuit 69 is connected to the CPU 50. The position change detection circuit 69 detects changes made to the stop positions of the reels 220 after they have been controlled to stop by the motor driving circuit 167.

Furthermore, the coin sensor 65 provided to the coin insertion part 9 and the bill sensor 66 provided to the bill insertion part 10 are connected to the CPU 50. The coin sensor 65 detects the coins inserted into coin insertion part 9, and the CPU 50 computes the number of the inserted coins on the basis of the coin detection signal outputted from the coin sensor 65. The bill sensor 66 detects the kind and amount of the bill inserted into the bill insertion part 10, and the CPU 50 computes the amount of the bill and the number of coins equivalent to the bill, based on the bill detection signal outputted from the bill sensor 66.

A hopper 71 is connected to the CPU 50 via a hopper driving circuit 70. When the CPU outputs a drive signal to the hopper driving circuit 70, the hopper 71 pays out a predetermined number of coins from the coin payout opening 15.

The coin detector 73 is connected to the CPU 50 via a payout completion signal circuit 72. The coin detector 73 is provided to the inside of the coin payout opening 15. The coin detector 73 outputs a coin payout detection signal to the payout completion signal circuit 72 when it has been detected that a pre-determined number of coins has been discharged through the coin payout opening 15. The payout completion signal circuit 72 outputs a payout completion signal to the CPU 50 based on these signals. Furthermore, the upper liquid crystal display 3 and the lower liquid crystal display 4 are connected to the CPU 50 via a liquid crystal driving circuit 74, and the upper liquid crystal display 3 and the lower liquid crystal display 4 are controlled by the CPU 50.

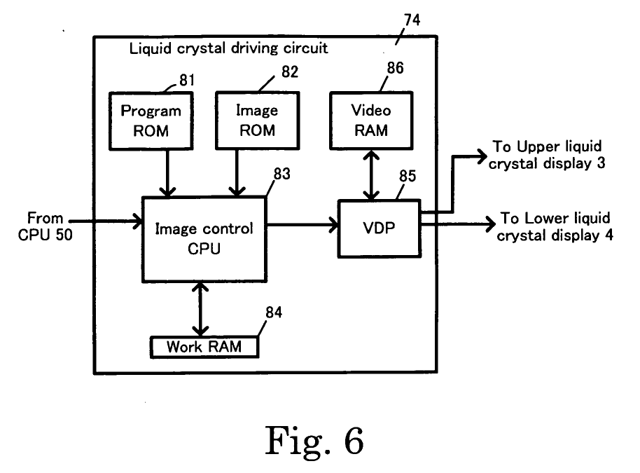

The liquid crystal driving circuit 74 comprises a program ROM 81, an image ROM 82, an image controller CPU 83, a work RAM 84, a VDP (Video Display Processor) 85, a video RAM 86, and the like, as shown in FIG. 6. Programs stored in the program ROM 81 control the images displayed on the upper liquid crystal display 3 and the lower liquid crystal display 4, as well as various kinds of selection tables. The image ROM 82 stores, for example, audiovisual presentations made by the upper liquid crystal display 3 and the lower liquid crystal display 4, various types of help information displayed by the upper liquid crystal display 3, the symbol sets 241 to 243 shown in FIG. 7 and displayed in the variable display windows 22 to 24 of the lower liquid crystal display 4, and other image-forming DOT data. The image controller CPU 83 determines, from among the DOT data stored in advance in the image ROM 82, the images to be displayed by the upper liquid crystal display 3 and the lower liquid crystal display 4. The determination is made according to the image control program stored in advance in the program ROM 81, and is based on the parameters set by the CPU 50. The work RAM 84 is structured as temporary memory means when the image control program is executed by the control CPU 83. The VDP 85 forms images according to the displayed content selected by the image control CPU 83, and outputs the images thus formed to the upper liquid crystal display 3 and the lower liquid crystal display 4. Therefore, for example, the symbol sets 241 to 243 shown in FIG. 7 are variably or statically displayed in the variable displays 22 to 24 (refer to FIG. 2). The video RAM 86 is structured as temporary memory means for forming images by the VDP 85.

In the slot machine 1 according to the present embodiment, the variable display windows 22 to 24 (refer to FIG. 2) of the lower liquid crystal display 4 can be made transmissive or non-transmissive by the liquid crystal driving circuit 74. Furthermore, during the game the reels 220 located on the back side of the variable display windows are rotated and stopped by the motor driving circuit 167 in the variable display windows 22 to 24 (refer to FIG. 2) in a transmissive state. Therefore, the symbol sets 241 to 243 (refer to FIG. 7) formed on the peripheral surfaces of the reels 220 are statically displayed after being variably displayed by scrolling. This is achieved using the transmissive variable display windows 22 to 24(refer to FIG. 2), through which the reels 220 are visible. In the non-transmissive variable display windows 22 to 24 (refer to FIG. 2), the liquid crystal driving circuit 74 statically displays the images of the symbol sets 241 to 243 (refer to FIG. 7) on the nontransmissive variable display windows 22 to 24 (refer to FIG. 2) through which the reels 220 located on the back side of the variable display windows are not visible. This occurs following the variable display of the images by scrolling.

Regardless of the transmissive or non-transmissive state of the variable display windows 22 to 24, the three symbol sets 241 to 243 are statically displayed in the variable display windows 22 to 24 when the goal is to cause the symbol sets variably displayed by scrolling to be statically displayed.

Various kinds of winning combinations are preliminarily set based on the combination of multiple types of symbols. When a combination of symbols corresponding to a winning combination is stopped on the pay line L, coins are discharged according to the winning combination through the coin payout opening 15. In this regard, the present slot machine functions in the same manner as a traditional slot machine. Therefore, an explanation regarding this point is omitted.

Referring back to FIG. 5, an LED 78 is connected to the CPU 50 via an LED driving circuit 77. When various types of presentations are made on the front side of the slot machine 1 with a multiple number of LEDs provided thereto, the LEDs 78 are controlled so as to be lit by the LED driving circuit 77 based on the drive signals from the CPU 50. Moreover, a sound output circuit 79 and a speaker 80 are connected to the CPU 50. The speaker 80 generates various types of sound effects based on the signal outputted from the sound output circuit 79 when various types of presentations are made.

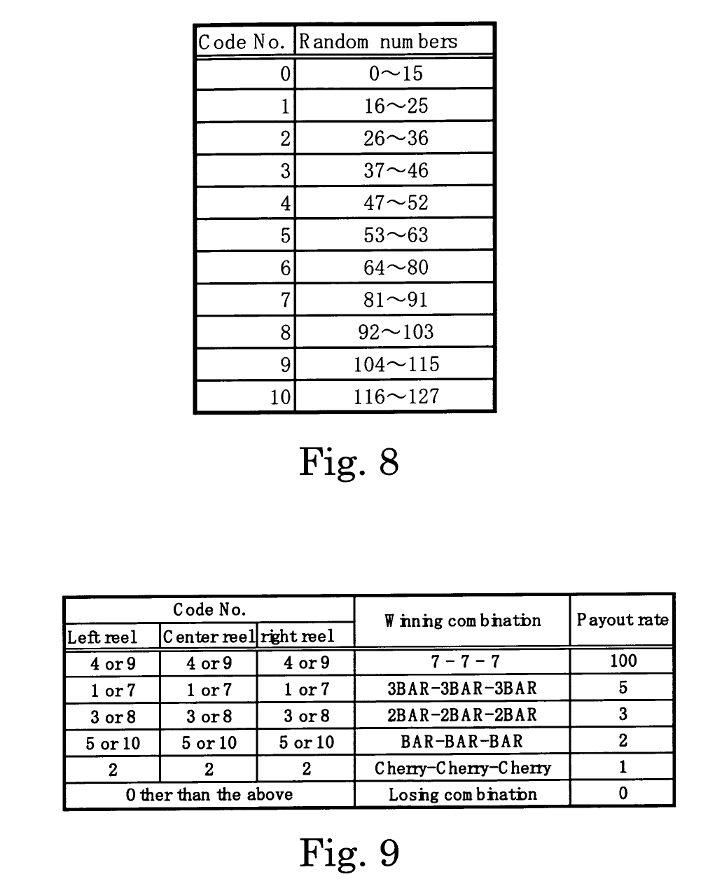

In the following, an explanation with reference to FIG. 8 regarding the lottery table used to determine the symbols which are to be statically displayed on the pay line L when conducting a game in the slot machine 1 by using the three variable display windows 22 to 24. FIG. 8 is an explanatory diagram showing the lottery table for the symbols to be statically displayed when a game is played using the three variable display windows. The lottery table shown in FIG. 8 is stored in the ROM 51.

The symbols to be statically displayed on the pay line L are determined for each of the variable display windows 22 to 24. In order to achieve the above, code numbers from “0” to “10” are assigned to the symbol sets 241 to 243 for each of the variable display windows 22 to 24 (shown in FIG. 7), sequentially in order from highest to lowest. On the other hand, the lottery table as shown in FIG. 8 is be prepared. Three random numbers is sampled by the random number sampling circuit 56 so as to correspond to each of the variable display windows 22 to 24.

For the sake of convenience in the following explanation, the symbol sets 241 for the left variable display window 22 are referred to as the “left reel,” the symbol sets 242 for the central variable display window 23 are referred to as the “central reel,” and the symbol sets 243 for the right variable display window 24 are referred to as the “right reel”.

As shown in the lottery table in FIG. 8, when the random number sampled through the random number sampling circuit 56 falls within the range from 0 to 15, a blank 96 assigned to the code number “0” is statically displayed on the pay line L with regards to the “left reel” of the symbol sets 241 on the left variable display window 22. The same procedures apply below to the code numbers from “1” to “10,” based on the lottery table shown in FIG. 8.

The same procedures as used with the “left reel” of the symbol sets 241 on the left variable display window 22 apply to the “central reel” of the symbol sets 242 on the central variable display window 23, as well as to the “right reel” of the symbol sets 243 on the right variable display window 24.

The following is an explanation in reference to FIG. 9 regarding the winning combination and the corresponding payout when conducting a game in the slot machine 1 using the three variable display windows 22 to 24. FIG. 9 is an explanatory diagram showing the winning combination and the corresponding payout when conducting a game using the three variable display windows. The table shown in FIG. 9 is stored in the ROM 51.

In FIG. 9, when the code numbers assigned to the “left reel,” “central reel,” and “right reel” are all either “4” or “9,” the combination “7-7-7” is won. In this case, sevens 94 are statically displayed on the pay line L in the variable display windows 22 to 24, and the player obtains the payout of “100.” The same procedures apply below to the payouts of “5,” “3,” “2,” and “1,” based on the table shown in FIG. 9.

When the code numbers assigned to the “left reel,” “central reel,” and “right reel” have a combination other than the combinations described above (namely, the combinations when the payouts are “100,” “5,” “3,” “2,” and “1”), a “losing combination” is obtained. In this case, either a triple BAR 91, a cherry 92, a double BAR 93, a seven 94, a single BAR 95, or a blank 96 is statically displayed on the pay line L in the variable display windows 22 to 24, and no payout is given to the player.

The following is an explanation with reference to FIGS. 10 to 15 regarding the table which is used to determine the transmissive or non-transmissive state of the variable display windows 22 to 24 when conducting a game in the slot machine 1 using the three variable display windows 22 to 24.

In the present embodiment, determination as to whether the variable display windows 22 to 24 are in a transmissive or non-transmissive state is made by selecting a pattern from among four patterns, in which the variable display windows 22 to 24 are either in a transmissive or non-transmissive state, by using a table provided for each winning combination (refer to FIGS. 10 to 15) as well as random numbers within a range of 0 to 7 sampled by the random number sampling circuit 56.

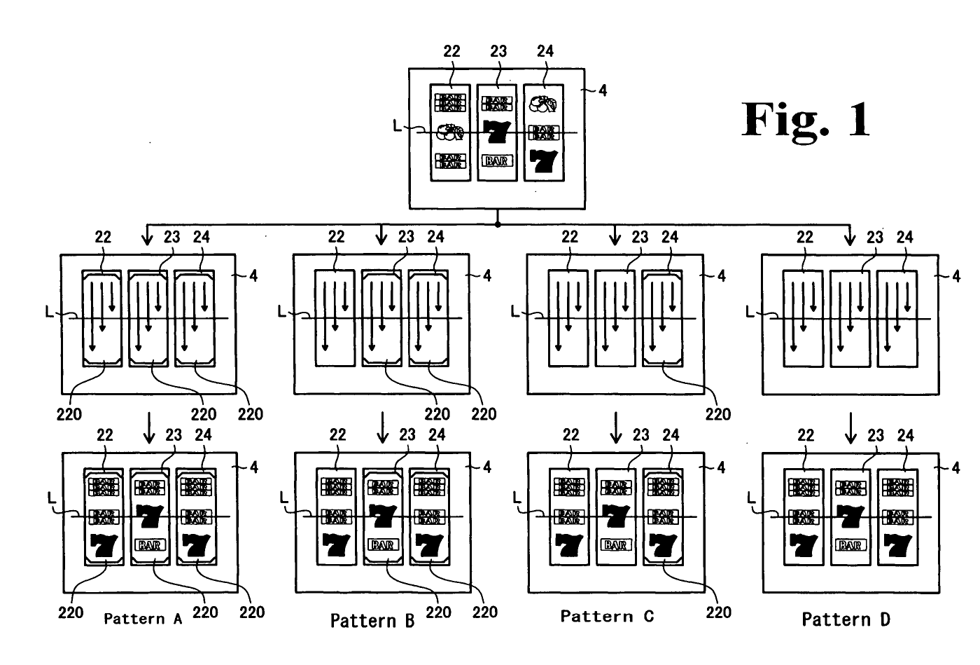

Prior to providing an explanation regarding the table shown in FIGS. 10 to 15, an explanation will be given regarding the four patterns in which the variable display windows 22 to 24 are either in a transmissive state or a non-transmissive state. As shown in FIG. 1, the four patterns are pattern A, pattern B, pattern C, and pattern D. In pattern A, all of the variable display windows 22, 23, and 24 are in a transmissive state. Therefore, the peripheral surfaces of the reels 220 are visible on any of the variable display windows 22, 23, and 24. In pattern B, the variable display window 22 is in a non-transmissive state, while the variable display windows 23 and 24 are in a transmissive state. Therefore, the peripheral surfaces of the reels 220 are visible only on the variable display windows 23 and 24. In pattern C, the variable display windows 22 and 23 are in a non-transmissive state, while the variable display window 24 is in a transmissive state. Therefore, the peripheral surfaces of the reels 220 are visible only on the variable display window 24. In pattern D, all of the variable display windows 22, 23, and 24 are in a non-transmissive state. Therefore, the peripheral surfaces of the reels 220 are not visible on any of the variable display windows 22, 23, and 24.

The following is an explanation of the tables shown in FIG. 10 to 15. FIG. 10 is an explanatory diagram showing the table which is used to determine the transmissive or non-transmissive state of the variable display windows in the case of hitting “7-7-7” when conducting a game by the three variable display windows. The table shown in FIG. 10 is stored in the ROM 51.

Specifically, hitting a “7-7-7” causes pattern A to be selected on the basis of the table shown in FIG. 10 when, for example, the random numbers sampled by the random number sampling circuit 56 fall within a range of 0 to 4. It is therefore determined that all the variable display windows 22, 23, and 24 are brought to the transmissive state with a probability of ⅝. The same procedures apply below to pattern B, pattern C, and pattern D, based on the table shown in FIG. 10.

Here, the number of transmissive display windows, through which respective reels disposed behind may be seen, is three (3), two (2), one (1), or zero (0) for pattern A, B, C, or D as shown in FIG. 10. Therefore, each expectation value, which may be given by multiplying the probability by the number of transmissive windows, is listed on the right column in the table. The summation of all expectation values are shown in the bottom cell of the column. Therefore, it is expected to have 2.25 windows transmissive when the “7-7-7” winning combination is hit. The player can recognize if the windows are transmissive or not.

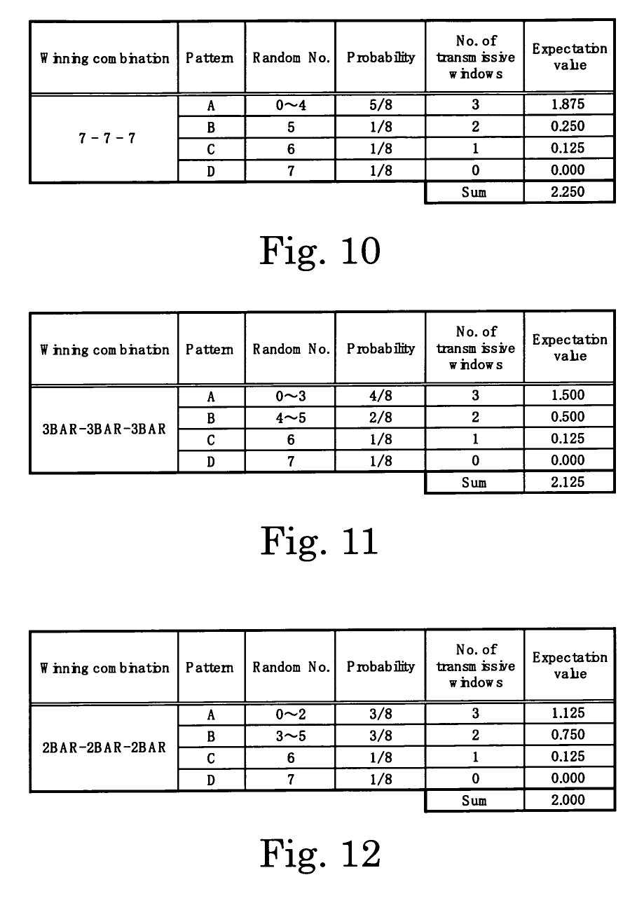

FIG. 11 is an explanatory diagram showing a table used to determine the transmissive or non-transmissive state of the variable display windows in the case of hitting a “3BAR-3BAR-3BAR” when conducting a game using the three variable display windows. The table shown in FIG. 11 is stored in the ROM 51.

Specifically, hitting a “3BAR-3BAR-3BAR” causes pattern A to be selected using the table shown in FIG. 11 when, for example, the random numbers sampled by the random number sampling circuit 56 fall within the range from 0 to 3. It is therefore determined that the variable display windows 22, 23, and 24 have a probability of 4/8 of being brought to a transmissive state. The same procedures apply below to pattern B, pattern C, and pattern D, based on the table shown in FIG. 11.

Here, the number of transmissive display windows, through which respective reels disposed behind may be seen, is three (3), two (2), one (1), or zero (0) for pattern A, B, C, or D as shown in FIG. 11. Therefore, each expectation value, which may be given by multiplying the probability by the number of transmissive windows, is listed on the right column in the table. The summation of all expectation values are shown in the bottom cell of the column. Therefore, it is expected to have 2.125 windows transmissive when the “3BAR-3BAR-3BAR” winning combination is hit.

FIG. 12 is an explanatory diagram showing a table used to determine the transmissive or non-transmissive state of the variable display windows in the case of hitting a “2BAR-2BAR-2BAR” when conducting a game using the three variable display windows. The table shown in FIG. 12 is stored in the ROM 51.

Specifically, hitting a “2BAR-2BAR-2BAR” causes pattern A to be selected using the table shown in FIG. 12 when, for example, the random numbers sampled by the random number sampling circuit 56 fall within a range of 0 to 2. It is therefore determined that all the variable display windows 22, 23, and 24 have a probability of ⅜ of being brought to a transmissive state. The same procedures apply below to pattern B, pattern C, and pattern D, based on the table shown in FIG. 12.

Here, the number of transmissive display windows, through which respective reels disposed behind may be seen, is three (3), two (2), one (1), or zero (0) for pattern A, B, C, or D as shown in FIG. 11. Therefore, each expectation value, which may be given by multiplying the probability by the number of transmissive windows, is listed on the right column in the table. The summation of all expectation values are shown in the bottom cell of the column. Therefore, it is expected to have 2.000 windows transmissive when the “2BAR-2BAR-2BAR” winning combination is hit.

FIG. 13 is an explanatory diagram showing a table used to determine the transmissive or non-transmissive state of the variable display windows in the case of hitting a “BAR-BAR-BAR” when conducting a game using the three variable display windows. The table shown in FIG. 13 is stored in the ROM 51.

Specifically, hitting a “BAR-BAR-BAR” causes pattern B to be selected using the table shown in FIG. 13 when, for example, the random numbers sampled by the random number sampling circuit 56 fall within a range of 1 to 5. It is therefore determined that all the variable display windows 22, 23, and 24 have a probability of ⅝ of being brought to a transmissive state. The same procedures apply below to pattern A, pattern C, and pattern D, based on the table shown in FIG. 13.

Here, the number of transmissive display windows, through which respective reels disposed behind may be seen, is three (3), two (2), one (1), or zero (0) for pattern A, B, C, or D as shown in FIG. 11. Therefore, each expectation value, which may be given by multiplying the probability by the number of transmissive windows, is listed on the right column in the table. The summation of all expectation values are shown in the bottom cell of the column. Therefore, it is expected to have 1.750 windows transmissive when the “BAR-BAR-BAR” winning combination is hit.

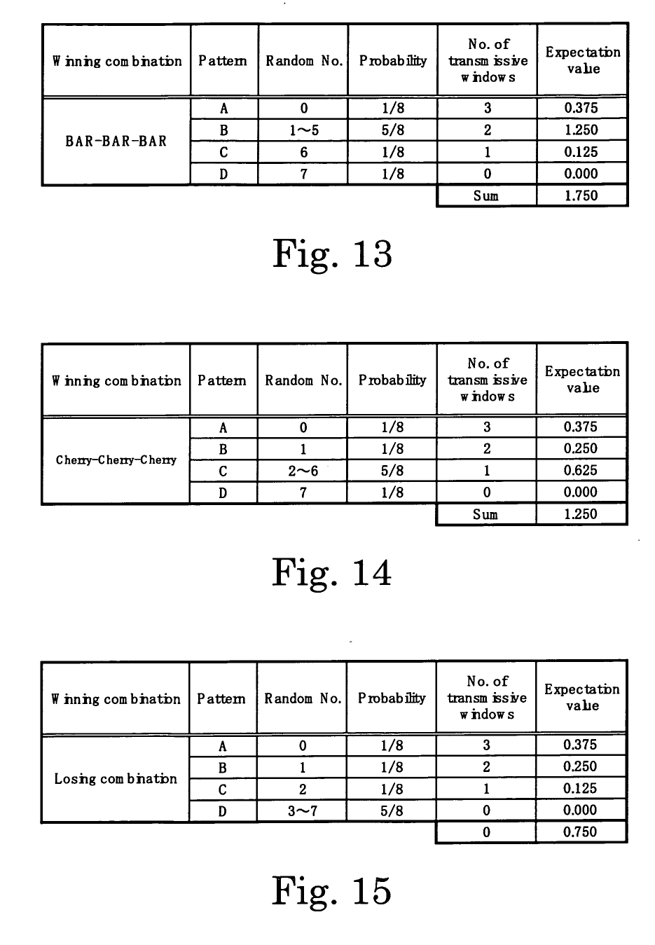

FIG. 14 is an explanatory drawing showing a table used to determine the transmissive or non-transmissive state of the variable display windows in the case of hitting a “Cherry-Cherry-Cherry” when conducting a game using the three variable display windows. The table shown in FIG. 14 is stored in the ROM 51.

Specifically, hitting a “Cherry-Cherry-Cherry” causes pattern C to be selected using the table shown in FIG. 14, when, for example, the random numbers sampled by the random number sampling circuit 56 fall within a range of 2 to 6. It is therefore determined that all the variable display windows 22, 23, and 24 have a probability of ⅝ of being brought to a transmissive state. The same procedures apply below to pattern A, pattern B, and pattern D, based on the table shown in FIG. 14.

Here, the number of transmissive display windows, through which respective reels disposed behind may be seen, is three (3), two (2), one (1), or zero (0) for pattern A, B, C, or D as shown in FIG. 11. Therefore, each expectation value, which may be given by multiplying the probability by the number of transmissive windows, is listed on the right column in the table. The summation of all expectation values are shown in the bottom cell of the column. Therefore, it is expected to have 1.250 windows transmissive when the “Cherry-Cherry-Cherry” winning combination is hit.

FIG. 15 is an explanatory diagram showing a table used to determine the transmissive or non-transmissive state of the variable display windows in the case of hitting “the losing combination” when conducting a game using the three variable display windows. The table shown in FIG. 15 is stored in the ROM 51.

Specifically, hitting a “losing combination” causes pattern D to be selected using the table shown in FIG. 15 when, for example, the random numbers sampled by the random number sampling circuit 56 fall within a range of 3 to 7. It is therefore determined that all the variable display windows 22, 23, and 24 have a probability of ⅝ of being brought to a transmissive state with a ⅝. The same procedures apply below to pattern A, pattern B, and pattern C, based on the table shown in FIG. 15.

Here, the number of transmissive display windows, through which respective reels disposed behind may be seen, is three (3), two (2), one (1), or zero (0) for pattern A, B, C, or D as shown in FIG. 11. Therefore, each expectation value, which may be given by multiplying the probability by the number of transmissive windows, is listed on the right column in the table. The summation of all expectation values are shown in the bottom cell of the column. Therefore, it is expected to have 0.750 windows transmissive when the “losing combination” is hit. Since the player can recognize if the display window is transmissive or not during the variable display, the player expects that he may get a higher winning combination if the number of transmissive display windows is higher.

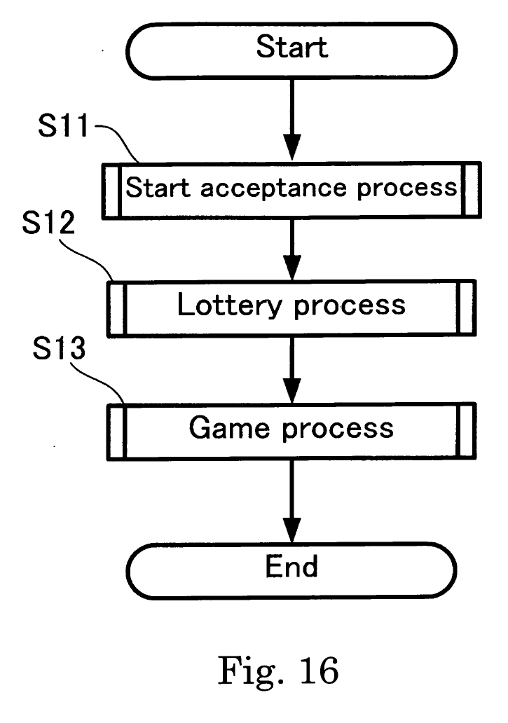

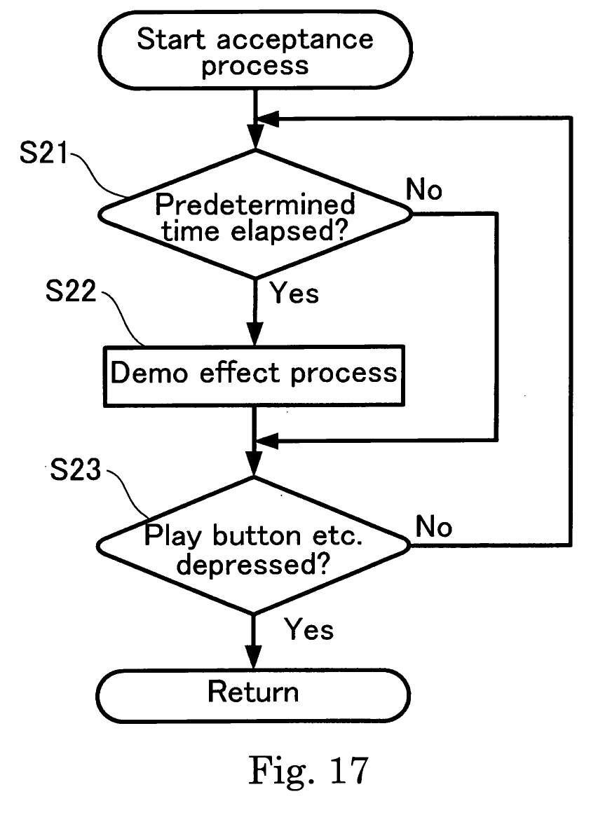

The following is an explanation of a main process program executed in the slot machine 1, made with reference to FIG. 16. FIG. 16 is a flowchart of the main process program. In FIG. 16, the start acceptance process program to be described later shown in FIG. 17 is first executed in step (hereafter, abbreviated as “S”) 11. This is a process for accepting the switch signals outputted from the SPIN/REPEAT BET switch 58, 1-BET switch 59, 3-BET switch 60, and 5-BET switch 61, based on the operations of the SPIN/REPEAT BET button 12, 1-BET button 11, 3-BET button 13, and 5-Bet button 14. When this process starts, the variable display windows 22, 23, and 24 are brought to a non-transmissive state. The game is started when the switch signals outputted from the switches are accepted.

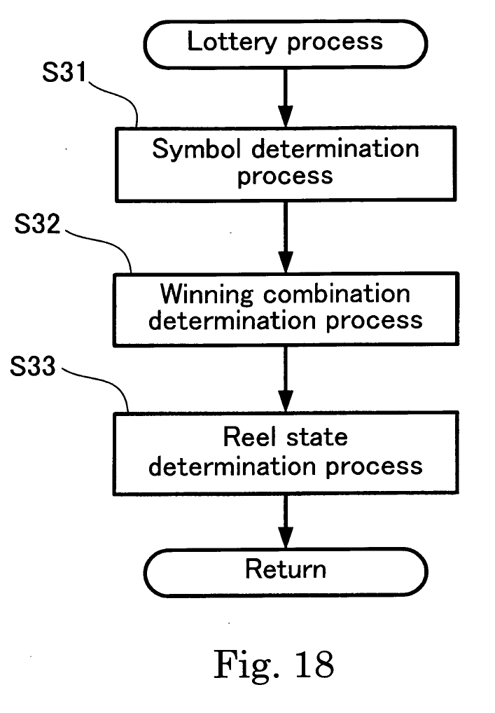

In S12, the lottery operation shown in FIG. 18 is performed based on the switch signals outputted from the spin (“SPIN/REPEAT BET”) switch 58, 1-BET switch 59, 3-BET switch 60, and 5-BET switch 61.

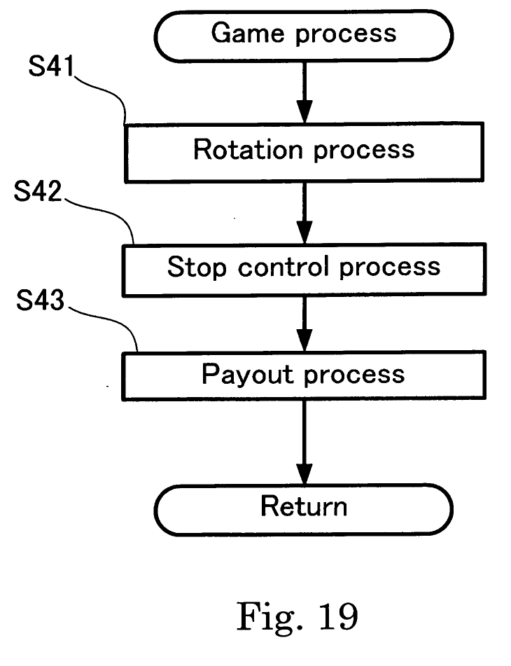

In the subsequent S13, the game process to be described later shown in FIG. 19 is performed, and the main process program is subsequently completed.

In the following, an explanation of the start acceptance process program executed in the slot machine 1 is made with reference to FIG. 17. FIG. 17 is a flowchart of the start acceptance process program. The start acceptance process is performed in S11 of the main process program shown in FIG. 16. To achieve this object, the process first proceeds to S21 shown in FIG. 17 to determine whether a pre-determined time period (for example, 15 seconds) has elapsed. If it is determined that the pre-determined time period has not elapsed (S21: NO), the process proceeds to S23 without conducting any operation. However, if it is determined that the pre-determined time period has elapsed (S21: YES), an audiovisual presentation is made in the upper liquid crystal display 3 and the lower liquid crystal display 4 in S22, and the process proceeds to S23. In S23, it is determined whether or not the spin (“SPIN/REPEAT BET”) button 12, 1-BET button 11, 3-BET button 13, and 5-BET button 14 have been operated. If it is determined that the 1-BET button 11 or the like has not been operated (S23: NO), the process returns to S21 to repeat the process described above. If it is determined that the 1-BET button 11 and the like have been operated (S23: YES), the process returns to the main process program shown in FIG. 16, and proceeds to the lottery operation in S12 even if the machine is in the middle of an audiovisual presentation.

In the following, an explanation of the lottery program executed in the slot machine 1 is made with reference to FIG. 18. FIG. 18 is a flowchart of the lottery program. The lottery operation is performed in S12 of the main process program shown in FIG. 16. To achieve this object, the process first proceeds to S31 shown in FIG. 18 to conduct the symbol determination process. The symbols to be statically displayed on the pay line L during the game (S42 shown in FIG. 19 below) are thereby determined for each of the variable display windows 22, 23, and 24. Specifically, as described above, three random numbers are sampled from a range of 0 to 127 by the random number sampling circuit 56 so as to correspond to each of the variable display windows 22, 23, and 24; and the symbols to be statically displayed are determined based on the lottery table shown in FIG. 8. When the symbols to be statically displayed on pay line L have been determined, a combination-determining process is performed in S32. In this combination-determining process, specifically, the winning combination and its payout are determined via the code numbers in S31 on the basis of the lottery table shown in FIG. 9, as described earlier.

In S33, a reel condition determination process is performed. In this reel condition determination process, specifically, a pattern is determined after being selected from four patterns in which the variable display windows 22 to 24 are either in the transmissive state or non-transmissive state. The determination is made based on the tables shown in FIGS. 10 to 15 and provided for each winning combination, and on random numbers sampled from a range of 0 to 7 by the random number sampling circuit 56, as described above. For example, hitting a “7-7-7” in S32 causes the random number 5 to be sampled in S33, whereupon pattern B is selected using the table shown in FIG. 10. It is therefore determined that the variable display window 22 is brought to a non-transmissive state, while the variable display windows 23 and 24 are brought to a transmissive state.

The process subsequently returns to the main process program shown in FIG. 16, and proceeds to the game process in S13.

In the following, an explanation of the game process program executed in the slot machine 1 is made with reference to FIG. 19. FIG. 19 is a flowchart of the game process program. The game process is performed in S13 of the main process program shown in FIG. 16. To achieve this object, rotation process is first performed according to S41 of FIG. 19. In this rotation process, specifically, the variable display windows 22, 23, and 24, which have previously been determined to be in a transmissive state in S33 shown in FIG. 18, are changed from a non-transmissive state to a transmissive state. According to S11 of FIG. 16, the reels 220 on the back side of variable display windows 22, 23, and 24, which have previously been determined to be in a transmissive state in S33 shown in FIG. 18, also begin to be rotated based on the switch signals outputted from the SPIN/REPEAT BET switch 58, 1-BET switch 59, 3-BET switch 60, and 5-BET switch 61. On the other hand, the variable display windows 22, 23, and 24, which have previously been determined to remain in the non-transmissive state in S33 shown in FIG. 18, maintain their non-transmissive state, and the images of the symbol sets 241, 242, and 243 are scrolled.

Therefore, when, for example, pattern B is selected in S33 shown in FIG. 18, images of the symbol sets 241 are variably displayed on the variable display window 22 in the non-transmissive state by scrolling in the non-transmissive variable display window 22, through which the reels 220 located on the back side of the display are not visible. In the variable display windows 23 and 24, which are in a transmissive state, the reels 220 located on the back sides of the displays start to rotate at the same time. The images of the symbol sets 242 and 243 formed on the peripheral surfaces of the reels 220 are variably displayed by scrolling in the transmissive variable display windows 23 and 24, through which the reels 220 located on the back side of the displays are visible. The symbols are therefore variably displayed.

Regardless of whether or not a determination has been made that variable display windows 22, 23, and 24 are in a transmissive state in S33 shown in FIG. 18, all of the reels 220 located on the back sides of the displays may begin to rotate in S41.

Subsequently, a stop control process is performed in S42. In the stop control process, specifically, the symbol sets 241, 242, and 243 are stopped in the variable display windows 22, 23, and 24 in the non-transmissive state. At the same time, the rotation of the reels 220 located on the back sides of the variable display windows 22, 23, and 24 in the transmissive state is stopped, thereby stopping the symbol sets 241, 242, and 243 that are formed on the peripheral surfaces of each of the reels 220 and are scrolled on the transmissive variable display windows 23 and 24 through which the corresponding reels 220 are visible. The symbols are thereby statically displayed.

Regardless of whether or not it has been determined that variable display windows 22, 23, and 24 are in the transmissive state in S33 shown in FIG. 18, the rotation of all three reels 220 is stopped in S42 in cases in which all the three reels 220 located on the back sides of the displays begin to rotate in S41.

In S43, coins or other items equivalent to the pre-determined payout are discharged based on the table shown in FIG. 9 and in accordance with the winning combination of symbols statically displayed on the variable display windows 22, 23, and 24 in S42. When the process of S43 is performed, the main process program shown in FIG. 16 is completed, and the main process program shown in FIG. 16 is started As described above, the CPU 50 operates as the “reel control means” in executing S41 and S42 shown in FIG. 19.

The CPU 50 operates as the “display control means” in executing S41 and S42 shown in FIG. 19.

The CPU 50 operates as the “determining means” in executing S33 shown in FIG. 18.

The CPU 50 operates as the “game control means” in executing S43 shown in FIG. 19.

Specifically, in the slot machine 1 of the present embodiment, all the variable display windows 22, 23, and 24 are in a non-transmissive state at the time the game is started, as shown in FIG. 1. When the game is started, the symbols are variably or statically displayed by means of the four patterns, i.e., pattern A, pattern B, pattern C, and pattern D, which are either in a transmissive state or a non-transmissive state. This is done by combining the drawn winning combinations and the sampled random numbers in the variable display windows 22, 23, and 24 (refer to the tables in FIG. 10 to 15).

In pattern A, all the variable display windows 22, 23, and 24 are in a transmissive state. Therefore, the symbol sets 241, 242, and 243 formed on the peripheral surface of each of the reels 220 are variably or statically displayed via the transmissive variable display windows 22, 23, and 24 through which each of the reels 220 are visible. Therefore, it can be said that, in any of the variable display windows 22, 23, and 24, the variable or static display of the symbols is performed by means of the mechanical reels in pattern A.

In pattern B, the variable display window 22 remains in the non-transmissive state, while the variable display windows 23 and 24 are in the transmissive state. Therefore, the images of the symbol sets 241 are variably or statically displayed in the non-transmissive variable display window 22 through which the corresponding reel 220 is invisible. On the other hand, the symbol sets 242 and 243 formed on the peripheral surface of each of the reels 220 are variably or statically displayed in the transmissive variable display windows 23 and 24 through which the respective reels 220 are visible. Therefore, it can be said that, the variable or static display of the symbols is performed by means of video reels in the variable display window 22 in pattern B, and that the variable or static display of the symbols is performed by means of mechanical reels in the variable display windows 23 and 24 in pattern B.

In pattern C, the variable display windows 22 and 23 remain in a non-transmissive state, while the variable display window 24 is in a transmissive state. Therefore, the images of the symbol sets 241 and 242 are variably or statically displayed in the non-transmissive variable display windows 22 and 23 through which the respective reels 220 are invisible. On the other hand, the symbol sets 243 formed on the peripheral surface of the reels 220 are variably or statically displayed in the transmissive variable display window 24 through which the corresponding reel 220 is visible. Therefore, it can be said that, the variable or static display of the symbols is performed by means of video reels in the variable display windows 22 and 23 in pattern C, and that the variable or static display of the symbols is performed by means of mechanical reels in the variable display window 24.

In pattern D, the variable display windows 22, 23, and 24 remain in a non-transmissive state. Therefore, the images of the symbol sets 241, 242, and 243 are variably or statically displayed in the non-transmissive variable display windows 22, 23, and 24 through which the respective reels 220 are invisible. Therefore, it can be said that the variable or static display of the symbols is performed by means of video reels in pattern D in any of the variable display windows 22, 23, and 24.

Accordingly, in the slot machine 1 of the present embodiment, the reels 220 visible through the variable display windows 22, 23, and 24 of the lower liquid crystal display 4 are mechanically rotated and stopped (S41, S42), whereby the symbol sets 241, 242, and 243 provided around the periphery of the variable display windows 22, 23, and 24 are variably or statically displayed in the variable display windows 22, 23, and 24. In addition, the symbol sets 241, 242, and 243 are variably or statically displayed as images on the variable display windows 22, 23, and 24 of the liquid crystal display 4 through which the reels 220 are invisible (S41, S42). It is thereby possible to jointly use “mechanical reels” and video reels in a superposed manner.

At this moment, a determination as to whether or not the reels 220 in the variable display windows 22, 23, and 24 of the lower liquid crystal display 4 have changed from a non-transmissive state to a transmissive state is made by selecting a pattern from among the four patterns (pattern A, pattern A, pattern A, and pattern A) in which the respective reels are in either the transmissive state or the non-transmissive state (S33). This determination is made based on the tables shown in FIGS. 10 to 15 and provided for each winning combination, and on the random numbers sampled from a range of 0 to 7 through the random number sampling circuit 56. According to the determination made above, changing the state of the respective variable display windows in either the transmissive or non-transmissive state allows the following symbol combinations to be displayed and presented: symbols that are formed on the peripheral surfaces of the reels 220 and that are statically displayed via the variable display windows 22, 23, and 24 of the lower liquid crystal display 4 through which the reels 220 are visible, and/or images of symbols statically displayed through the variable display windows 22, 23, and 24 of the lower liquid crystal display 4 through which the reels 220 are invisible (S41, S42).

In the tables of FIGS. 10 to 15 provided for each winning combination, the probability distribution for each pattern's selection from among the four patterns (pattern A, pattern B, pattern C, and pattern D) is set for each winning combination with a different payout. Therefore, it becomes possible to heighten the player's expectations to obtain a payout, depending on the number of the variable display windows 22, 23, and 24 of the lower liquid crystal display 4 through which the reels 220 are visible (or invisible). For example, the probability of pattern A being selected, in which all the variable display windows 22, 23, and 24 of the lower liquid crystal display 4 are changed from the non-transmissive state to the transmissive state, is the highest when a winning combination of “7-7-7” is hit (refer to FIGS. 9 to 15). When the player sees that all of the variable display windows 22, 23, and 24 of the lower liquid crystal display 4 have changed from the non-transmissive state to the transmissive state, the player's expectation is that a winning combination of “7-7-7” with the highest possible payout might have been hit.

The present invention is not limited to the embodiment described above, and may include various modifications made to it as long as the modifications do not deviate from the essence of the invention.

For example, in the slot machine 1 of the present embodiment, as described above, a determination as to whether or not the variable display windows 22, 23, and 24 of the lower liquid crystal display 4 are changed from the non-transmissive state to the transmissive state is made by selecting a pattern from among the four patterns (pattern A, pattern B, pattern C, and pattern D; S33). The determination is made based on the tables provided for each winning combination shown in FIGS. 10 to 15, and on the random numbers sampled from a range of 0 to 7 by the random number sampling circuit 56. However, the patterns in the transmissive or non-transmissive state are not limited to these four patterns (pattern A, pattern B, pattern C, and pattern D). For example, the following patterns may be used instead or in addition to the existing four patterns (pattern A, pattern B, pattern C, and pattern D): a pattern in which the variable display window 23 is kept in the non-transmissive state, and the variable display windows 22 and 24 are changed from the non-transmissive state to the transmissive state; a pattern in which the variable display window 24 is kept in the non-transmissive state, and the variable display windows 22 and 23 are changed from the non-transmissive state to the transmissive state; a pattern in which the variable display windows 23 and 24 are kept in the non-transmissive state, and the variable display window 22 is changed from the non-transmissive state to the transmissive state; and a pattern in which the variable display windows 22 and 24 are kept in the non-transmissive state, and the variable display window 23 is changed from the non-transmissive state to the transmissive state. In addition, changing the non-transmissive state to the transmissive state for the variable display windows 22, 23, and 24 may be determined by lot drawing, with probabilities that vary depending on the winning combination. Moreover, changing the non-transmissive state to the transmissive state for the variable display windows 22, 23, and 24 may be determined by calculation, for example, rather than by performing lot drawings on the basis of the tables shown in FIG. 10 to 15.

Furthermore, in the slot machine 1 according to present embodiment, all of the variable display windows 22, 23, and 24 are changed to the non-transmissive state when the start acceptance process shown in FIG. 17 is initiated. It is also possible, however, for the transmissive state of the previous game to be maintained until immediately prior to S41 in which the game process shown in FIG. 19 is performed for the current game.

Moreover, in the slot machine 1 according to the present embodiment, the state of the variable display windows 22, 23, and 24, being determined to have been changed to the transmissive state in S33 in FIG. 18, is changed from the non-transmissive state to the transmissive state in the rotation process in S41 shown in FIG. 19. It is also possible, however, to adopt an arrangement in which the variable display windows 22, 23, and 24 having been determined in S33 in FIG. 18 to have been changed from the non-transmissive state to the transmissive state, are changed from the non-transmissive state to the transmissive state immediately before the rotation has been stopped of the reels 220 located on the back sides of the variable display windows 22, 23, and 24 being determined to have changed from the non-transmissive state to the transmissive state in the stop control process of S42 in FIG. 19. In such case, however, the images of the symbol sets 241, 242, and 243 are variably displayed by scrolling in the variable display windows 22, 23, and 24 until immediately before the change is made to the transmissive state.

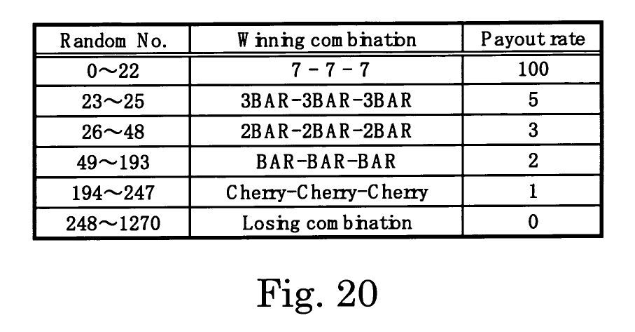

Moreover, in the slot machine 1 according to present embodiment, the symbols to be statically displayed on the pay line L are determined for each of the variable display windows 22, 23, and 24 by means of random numbers sampled by the random number sampling circuit 56 in the lot drawing in S12, as shown in FIG. 8 and 9. It is also possible, however, to adopt an arrangement in which all the symbols to be statically displayed on the pay line L on the variable display windows 22, 23, and 24 are determined based on random numbers sampled by the random number sampling circuit 56. To achieve this object, the lottery table for winning combinations shown in FIG. 20 is used. FIG. 20 is an explanatory diagram showing the lottery table for winning combinations and the corresponding payouts.

In FIG. 20, the random numbers that are used in the lottery table for selecting the winning combination range from 0 to 1270. When the random numbers sampled via the random number sampling circuit 56 fall within a range of 0 to 22, a winning combination of “7-7-7” is obtained, and the player receives a payout of “100.” Hereafter, the same procedures apply to the payouts of “5,” “3,” “2,” and “1,” based on the table shown in FIG. 20.

If the random numbers sampled fall within a range of 248 to 1270, “a losing combination” is selected. In this case, a combination of symbols other than those described above are statically displayed on the pay line L in the variable display windows 22, 23, and 24, and no payout is provided.

Moreover, the slot machine 1 according to the present embodiment is used to play only ordinary games, but an arrangement may also be adopted in which, for example, an ordinary game is played and a free game is then played immediately after S13 in FIG. 16. Such free games are generally designed to be advantageous for the player in many cases. For example, when the activities shift to a free game on the condition that specific symbols be statically displayed, the player can continuously play 10 games, 20 games, 30 games, or the like in accordance with the rank of the free game without betting any coins or the like. In such free games, the probability of winning various winning combinations is usually set higher. Therefore, the player can often win a large amount of coins.

Three reels are used in the slot machine 1 according to the present embodiment, but the number of reels is not limited, and five or nine reels may also be used, for example. In particular, using nine reels can heighten the player's expectations of a payout by bringing only the variable display window in the exact center to a non-transmissive or transmissive state.

In the above-mentioned embodiment, the video reel has the same kind of columns of symbols as the mechanical reels have. However, the video reel may have different kinds of columns of symbols. By way of example, as shown in FIG. 7B, the columns of symbols for the video reel may have more SEVEN (“7”) symbols such that it can be made more likely to win the SEVEN winning combination. Therefore, the player may enjoy various probabilities to win the winning combinations.

The present invention may be applied to gaming machines in which “mechanical reels” or video reels are used.

Further, a gaming machine as described below may be provided.

According to the present invention, a gaming machine (e.g., slot machine 1) comprises: a display device (e.g., lower liquid crystal device 4) including a plurality of display windows; a plurality of reels (e.g., reels 220), respective peripheral surfaces on which a plurality of symbols are arranged, the plurality of reels being disposed behind and in an opposing manner to the plurality of display windows of the display device (e.g., lower liquid crystal device 4), respectively; transparency control means (e.g., liquid crystal driving circuit 74) for making each of the plurality of display windows of the display device in a state disenabling a transmissive display of each of the plurality of reels (e.g., reels 220) disposed behind each of the display windows and a state enabling the transmissive display of each of the plurality of reels (e.g., reels 220) switchably; reel control means (e.g., CPU 50, S41, S42) for displaying variably and statically the plurality of symbols through the display windows by rotating and stopping the reels (e.g., reels 220) mechanically, which are visible through the display windows of the display device (e.g., lower liquid crystal device 4); display control means for displaying variably and statically the plurality of symbols in the display windows of the display device (e.g., lower liquid crystal device 4) which is in a state disenabling the transmissive display of each of the plurality of reels (e.g., reels 220) disposed behind; lottery means (e.g., CPU 50, S12) for conducting a lottery to select a combination of symbols to be composed of image symbols to be displayed statically in the display windows when the reels (e.g., reels 220) disposed behind and the symbols displayed statically thereon are not visible through the display windows of the display device (e.g., lower liquid crystal device 4) in the state disenabling the transmissive display of the plurality of reels disposed behind; determination means (e.g., CPU 50, S33) for determining a display window to be operated by the transparency control means (e.g., liquid crystal driving circuit 74) based on a combination of symbols selected by the lottery means (e.g., CPU 50, S12); and game control means (e.g., CPU 50, S43) for paying out respective payout amount corresponding to the selected winning combination when a combination of symbols selected by the lottery means (e.g., CPU 50, S12) includes one or more winning combination of symbols.

As described above, according to the present invention, as visible reels through display windows of the display device are mechanically rotated and stopped, the plurality of symbols being disposed on the peripheral surfaces of the reels are displayed variably and statically through the display windows. And video images of a plurality of symbols are displayed variably and statically in display windows of the display device in a state disenabling the transmissive display of the reels provided behind the display device. Therefore, the “mecha-reel” and the video reel are employed in a superposed manner such that display effects of a combination of symbols comprising symbol images to be displayed statically in the display windows of the display device in a state disabling the transmissive display of the reels disposed behind the display device and/or symbols disposed on the reels to be displayed statically through the display windows of the display device in a state enabling the transmissive display of the reels disposed behind the display device as each of the display windows of the display device is determined to be from in the state disenabling the transmissive display to in the state enabling the transmissive display if the reels disposed behind the display device based on the combination of symbols selected by the lottery. Therefore, the player may expect higher probability to wind the payout depending on the number of display windows of the display device in the state enabling (or disenabling) the transmissive display of the reels.

What is claimed is:

1. A gaming machine comprising:
a plurality of display windows being composed of a video display which can display variably and statically images of a plurality of symbols;
a plurality of mechanical reels being disposed behind the plurality of display windows, respectively, and being composed of peripheral surfaces on which a plurality of symbols are disposed, the plurality of symbols being displayed variably and statically through the plurality of display windows as the windows are in a transmissive state; and
a processor in communication with the display windows and the reels, the processor operable to:
(a) select a plurality of symbols to be displayed statically as a game result by lottery;
(b) determine whether each of the plurality of display windows is made in the transmissive state or a non-transmissive state based on a combination of the selected symbols;
(c) display symbols of reels through corresponding display windows in the transmissive state and images of symbols on display windows in the non-transmissive state as the game result; and
(d) award a player based on the game result when the game result corresponds to a predetermined winning combination of symbols.

2. The gaming machine according to claim 1 wherein the determination of the states of the respective display windows is made by lottery with probability corresponding to the combination of the selected symbols.

3. The gaming machine according to claim 1 wherein a number of display windows to be made in the transmissive state is determined by lottery with probability corresponding to the combination of the selected symbols.

4. The gaming machine according to claim 2 wherein the probability differs by the combination of the selected symbols.

5. The gaming machine according to claim 3 wherein the probability differs by the combination of the selected symbols.

6. The gaming machine according to claim 1 wherein a number of display windows to be made in the transmissive state is determined by lottery with a probability table corresponding to the combination of the selected symbols, the probability table including a higher expectation value of the number of display windows in the transmissive state when the combination corresponds to a higher award.
